(19) United States
(12) Patent Application Publication
(10) Pub. No.: US 2009/0325127 A1
(43) Pub. Date: Dec. 31, 2009

(54) METHOD AND DEVICE FOR PRODUCING TOOTH PROSTHESIS PARTS

(75) Inventors: Jochen Kusch, Wachtberg (DE); Joachim Hey, Bornheim (DE); Lutz Ritter, Bornheim (DE)

Correspondence Address: FITZPATRICK CELLA HARPER & SCINTO, 1290 Avenue of the Americas, NEW YORK, NY, 10104-3800, US

(73) Assignee: SICAT GMBH & CO. KG

(21) Appl. No.: 12/282,834

(22) PCT Filed: Mar. 22, 2007
(86) PCT No.: PCT/EP07/52768

§ 371 Date: Mar. 9, 2009

(30) Foreign Application Priority Data
Mar. 24, 2006 (DE) 10 2006 013 534.2

(51) Int. Cl. A61C 13/08; G06F 17/50

(52) U.S. Cl. 433/201.1; 700/98

(57) ABSTRACT

The invention relates to a method for producing tooth prosthesis parts comprising an implant for inserting into the jaw and a prosthesis for securing to an implant by means of a connecting surface (52). A first measuring data set of a 3D X-ray image is prepared in the region of the prosthesis which is to be inserted and is reproduced on a display unit (1) as a 3D X-ray model (20). A second measuring data set of a three-dimensional optical measurement of the visible surface of the jaw and of parts of the adjacent tooth (11, 12) is prepared in the region of the prosthesis which is to be inserted. The measuring data set of the 3D X-ray image is correlated with the measuring data set of the three-dimensional optical measurement in relation to the geometries. A data set of the prosthesis is prepared as a 3D prosthesis model (40). The 3D prosthesis model (40) is displayed to-scale in the correlated 3D X-ray model (20) on the display unit (1). A data set of the implant in the correlated 3D X-ray model (20) is displayed on the display unit as a 3D implant model (50) and can be positioned by input means (4, 5) in the correlated 3D X-ray model (20), taking into account the 3D prosthesis model (40) and the 3D X-ray model (20).

### BACKGROUND OF THE INVENTION

The present invention relates to a method for producing dental prosthetic items comprising an implant for implanting in the jaw and a prosthesis for attachment to the implant by means of an interconnecting area, which implant is positioned to match the prosthesis such that the prosthesis can be connected to the implant along the interconnecting area.

### PRIOR ART

DE 199 52 962 A1 discloses the production of drilling templates, where a radiograph, e.g. an X-ray 3D scan, is correlated with a three-dimensional optical scan and the data collected are implemented for planning the type of implant and for producing a drilling template, which contains the negative impressions of the surfaces of the neighboring teeth and an hole located at a predefined position.

At present, a number of dentist's appointments are required in order to provide a dental prosthesis to replace an individual tooth or a number of teeth. In a first step, an implant is planned with respect to its type, location, and angle and inserted as precisely as possible into the jaw after drilling an implant guide hole. In a second step, the precise location and orientation of the implant are measured using time-consuming and complicated procedures. For instance, a scan label with marks is mounted on the implant and imaged. The distances between the marks can be determined from the image and the position and orientation of the implant can be computed therefrom. In the third step, a prosthesis is planned and produced taking into consideration the position and orientation of the implant.

The prosthesis can be indirectly connected to the implant by way of an interconnecting member. Such interconnecting members must often be specially planned and produced so that the interconnecting member has an angle corresponding to the angle between the measured orientation of the implant and a planned interconnecting axis of the prosthesis. The disadvantage is that errors can occur when measuring the position and orientation of the implant to result in inaccuracy of fit of the prosthesis.

Based on the problem involved and the solutions disclosed in the prior art it is necessary to reduce the time required for providing the dental prosthesis and to increase the fitting accuracy of the prosthesis.

### SUMMARY OF THE INVENTION

According to the present invention, the objective outlined above can be achieved with a method for producing dental prostheses comprising an implant for implantation in the jaw and a prosthesis for attachment to the implant by means of an interconnecting area, in which method a first scanned data set collected from a 3D radiograph of the insertion site of the prosthesis is provided and displayed on a display unit as a 3D X-ray model. Furthermore, a second scanned data set collected from a three-dimensional optical scan of the visible surface of the jaw and at least parts of the neighboring teeth at the insertion site of the prosthesis is provided. The scanned data set collected from the 3D radiograph is correlated with the scanned data set collected from the three-dimensional optical scan as to their geometries. A data set of at least the surface of the prosthesis is provided as a 3D prosthesis model. The 3D prosthesis model is displayed in correct positional relationship in the correlated 3D X-ray model on the display unit. A data set collected from the implant is displayed in the correlated 3D X-ray model on the display unit as a 3D implant model. The 3D implant model can be positioned at least approximately by input means, but preferably automatically, in the correlated 3D X-ray model, taking into consideration the 3D prosthesis model and the 3D X-ray model, and optionally selected as to the type of implant and adjusted as to size.

Planning of the implant and the prosthesis is thus carried out jointly in the first step, in which information acquired from the prosthesis planning is implemented for planning the implant without requiring additional scanning of the implant, as is known from the prior art. In the second step, the selected implant is inserted into the jaw in accordance with the planned position and orientation, and the planned prosthesis is attached directly or indirectly to the implant.

Thus the method of the invention is only employed once the prosthesis planning has been carried out and serves for planning the implant. A large quantity of information acquired from the 3D prosthesis model, namely the location, orientation, shape, interface against the gingival surface, the type and the contact surfaces of the prosthesis to be inserted in relation to the neighboring teeth, is used for planning the implant. When planning the implant, the 3D X-ray model is also taken into consideration.

During automatic selection and positioning, the person carrying out the treatment must then check the 3D implant model and correct it, if appropriate.

The interconnecting area is a contact surface on the prosthesis. The prosthesis can be connected to the implant directly or indirectly, for example, by means of a separate interconnecting member or an extension of the implant.

The three-dimensional optical scan of the visible surface of the jaw at the prosthesis-insertion site includes the surfaces of at least parts of the neighboring teeth and the gingival surface.

Anatomical structures such as jawbones, root canals, and nerves located in the jaw beneath the visible surface are displayed in the 3D radiograph.

One advantage is the reduced time required for providing a dental prosthesis. The method of the invention makes it possible to select the implant, plan and produce the prosthesis, insert the implant into the jaw, and to mount the prosthesis within a single dentist's appointment by using a three-dimensional X-ray apparatus, a three-dimensional optical scanner, a prosthesis fabricating system, and a planning system.

In the case of implants that can be stressed immediately, the final prosthesis can be mounted directly after the insertion of the implant. Otherwise, a provisional prosthesis is initially mounted and the final prosthesis is mounted after the healing period of the implant inserted into the jawbone. The implant may shift slightly during the healing period. In such a case, a new three-dimensional optical scan and adjustment of the final prosthesis will be necessary.

Another advantage is that the production of the prosthesis in accordance with the method of the invention ensures a more accurate fit than when the prosthesis is produced only after measuring the position and orientation of the already inserted implant. The implant is adjusted more precisely to suit the prosthesis, since these two elements are planned jointly and no additional measurement errors, such as those occurring when scanning the implant, can impair the fitting accuracy.

Advantageously, the position and/or orientation and/or type and/or length and/or diameter of the 3D implant model can be determined automatically with reference to the 3D prosthesis model, namely the length and/or orientation and/or dimensions thereof and/or the interface of the prosthesis model against a gingival surface known from the three-dimensional optical scan and/or the contact surfaces of the prosthesis model against the neighboring teeth.

Thus, observation of the correlated display and the selection of the 3D implant model by the person carrying out the treatment are automated and the time required for the provision of a dental prosthesis is reduced.

The position and orientation of the 3D implant model can be selected automatically taking into consideration the anatomical structures in the jaw in the 3D X-ray model.

Since the 3D prosthesis model is predefined, the position and type of the prosthesis to be inserted for incisors or molars, for example, are known. Since the anatomical structures in different persons differ only slightly, a 3D prosthesis model can be selected automatically based exclusively on the position of the prosthesis to be inserted.

During the automatic selection of the 3D implant model, the anatomical structures in the jaw might be taken into account, provided a number of conditions are met. Firstly, the implant must be surrounded by the jawbone and be located at a minimum distance from the edge of the jawbone in order to ensure the required mechanical stability of the dental prosthesis. Secondly, the anatomical structures such as nerves and roots of the neighboring teeth and also any adjacent implants must be taken into consideration when inserting the implant. The distance of the 3D implant model from critical structures such as the edge of the jawbone, nerves, roots of the neighboring teeth, or adjacent implants should be at least 2 mm but may be defined arbitrarily, if desired.

Advantageously, the diameter and length of the 3D implant model can be selected automatically, taking into consideration the stress expected to be caused by contact forces on the contact surfaces of the prosthesis.

The prosthesis to be inserted has contact surfaces against the neighboring teeth and the opposing teeth. Unlike implants, natural tooth roots are held in the jawbone by the periodontium, which has a certain elasticity and permits slight movements of the teeth in relation to the jawbone. Thus, during masticatory movement, in particular, there are lateral movements of the natural neighboring teeth and stresses are thus caused due to contact forces on the interfaces between the prosthesis and the neighboring teeth. Furthermore, during mastication, stresses may be caused by contact forces on the contact surfaces of the prosthesis in relation to the opposing teeth.

The stresses expected to be caused on the contact surfaces of the prosthesis in relation to the neighboring teeth and the opposing teeth can be taken into account during automatic selection. These stresses may vary depending on the orientation of the implant. The diameter and length of the implant must be selected such that the implant is able to withstand the mechanical stresses expected while affecting the jawbone to the least possible extent. The implant is selected from a plurality of implants, the diameter of which may vary from 3 mm to 6 mm and the length of which may vary from 8 mm to 16 mm, for example. These dimensions come very close to the root dimensions of natural teeth. Molars usually have a plurality of shorter and thicker roots, while incisors have only one rather thin and long root. The occlusal surface of incisors does not extend normal to the orientation of the roots, as in the case of molars. Thus, a greater torque acts on the implants in the case of incisors as compared with molars, since the contact forces are transferred normal to the occlusal surface. As a result, prostheses for incisors require longer implants in order to absorb the contact forces in the jawbone.

The 3D implant model can advantageously have a longitudinal axis, the interconnecting area can have an interconnecting axis substantially corresponding to the insertion axis of the prosthesis, and the 3D prosthesis model can have a prosthesis axis which extends normal to the occlusal surface of the prosthesis in the case of molars and runs through the center of gravity of the prosthesis. In the case of incisors, the prosthesis axis does not extend normal to the occlusal surface but instead along the alveolar ridge supporting the teeth and through the center of gravity of the prosthesis. The 3D implant model can be modified in terms of its position and orientation such that the angle between the prosthesis axis and the interconnecting axis is 30° at most. This angle should be selected such that it is as small as possible in the case of molars, since this facilitates the insertion of the prosthesis. The interconnecting axis is oriented such that the insertion of the prosthesis along the insertion axis is obstructed by the neighboring teeth to not more than an insignificant extend.

Thus, for example, straight connections such as interconnecting members having coincident implant and interconnecting axes can be used obliquely in relation to the prosthesis axis. The prosthesis axis may deviate from the interconnecting axis by an angle of not more than 30°. During the implant-planning stage, it is necessary to allow for the fact that the interconnecting member is located within the prosthesis and at a distance of at least 2 mm from the surface thereof, in order to ensure the required mechanical stability of the prosthesis. Such constructions of interconnecting members extending obliquely in relation to the prosthesis axis may be necessary if they improve the transfer of the occurring forces to the implant. The interconnecting axis is selected such that the neighboring teeth do not obstruct the insertion of the prosthesis. This might be the case if the interconnecting axis and the prosthesis axis were located in a plane along the jaw.

Advantageously, the 3D implant model can have a longitudinal axis and the interconnecting area can have an interconnecting axis, which represents the direction of insertion of the prosthesis, and the angle of the longitudinal axis in relation to the interconnecting axis is selected automatically from a plurality of predefined angles ranging from 140° to 180°.

Thus, the longitudinal axis can be disposed relatively to the interconnecting axis such that a pre-fabricated interconnecting member having a defined angle ranging from 140° to 180° can be used. Consequently, it is not necessary to produce an interconnecting member that specifically matches the prosthesis to be inserted and that has a specific angle determined only by scanning the position and orientation of the implant. This reduces the time required for providing the dental prosthesis.

Advantageously, a data set of the interconnecting area can be displayed as a 3D interconnecting model in correct positional relationship in the correlated 3D X-ray model. The shape of the 3D prosthesis model is automatically adapted to the 3D interconnecting model.

When using an interconnecting member, its interconnecting area, which is displayed as a 3D interconnecting model, must be positioned within the 3D prosthesis model. The 3D prosthesis model is automatically adapted such that a recess corresponding to the 3D interconnecting model is included on the lower side of the 3D prosthesis model in order to provide an accurately fitting interconnection.

Advantageously, the scanned data set collected from a 3D radiograph can be displayed as a 3D X-ray model and the scanned data set collected from the three-dimensional optical scan can be displayed as a 3D restoration model on the display unit such that both scanned data sets are correlated with each other as to their geometries. An input means, preferably a slider, is provided for selecting a cross-fade ratio of the two models.

Information from the scanned data sets of the two images at the prosthesis insertion site can thus be made readily accessible to the person carrying out the treatment by means of the 3D display. The correlated display makes it possible for the person carrying out the treatment to observe otherwise hidden structures in the 3D radiograph in actual geometrical relationship to the visible surface in the three-dimensional optical scan and to select the position and orientation of the 3D implant model relatively to the prefabricated 3D prosthesis model while taking into consideration such structures.

The cross-fade ratio of the two models is selected with the help of input means, preferably a slider.

The cross-fade ratio determines the relative degree of visibility of the two models being displayed. The cross-fade ratio can also be adjusted with the aid of input means such that either only the 3D X-ray model or only the 3D restoration model is displayed.

The 3D prosthesis model can be displayed either as a tomographic image or as a solid body.

A drilling template can be constructed advantageously taking into consideration the selected position and orientation of the 3D implant model and based on the occlusal surface of the neighboring teeth obtained from the scanned data set collected from the three-dimensional scan.

The drilling template is made so as to fit the neighboring teeth accurately. Part of it can be a negative cast of the surfaces of the neighboring teeth in order to ensure a particularly accurate fit.

The drilling template can be advantageously formed such that it is also suitable for inserting the implant.

The drilling template serves for insertion of the planned implant at the planned site along the planned longitudinal axis. For this purpose, in a first step, a bore having a planned drilling depth and planned drilling diameter is produced, and in a second step the implant is inserted along the axis of this bore.

The prosthesis can advantageously be connected to the implant indirectly by means of a separate interconnecting member including the interconnecting area for the prosthesis, which interconnecting member is connected to the implant.

The interconnecting member is connected to the implant, at one end, and to the prosthesis, at the other end, by way of the interconnecting area. The interconnecting member can be formed such that it is rotationally symmetric about the interconnecting axis, which substantially corresponds to the insertion axis of the prosthesis. The interconnecting member is connected to the implant such that the longitudinal axis of the implant and the interconnecting axis enclose a planned angle.

An interconnecting recess in the prosthesis can be advantageously computed automatically in the direction of the interconnecting axis on the lower side of the prosthesis, which interconnecting recess corresponds to the interconnecting area of the interconnecting member and thus to the 3D interconnecting model, and is displayed in the 3D prosthesis model.

The interconnecting recess corresponds to a negative impression of the interconnecting area of the interconnecting member and is thus likewise oriented along the interconnecting axis. Planning of the interconnecting recess takes place automatically. Thus the time required for planning the prosthesis is reduced.

Advantageously, the position and orientation of the implant can be selected or automatically determined such that an interconnecting member can be used from a plurality of interconnecting members stored in a memory and have a predefined interconnecting area between the interconnecting member and the prosthesis on the one hand and a predefined angle between the interconnecting axis and the longitudinal axis of the implant on the other.

A plurality of interconnecting members are stored as a data set in the memory of a computer, for example. They show different interconnecting areas and different angles between the interconnecting axis and the longitudinal axis of the implant. The implant is planned in terms of its position and orientation such that one of these interconnecting members can be used. The stored interconnecting members may be pre-fabricated, so that it is no longer necessary to create a customized interconnecting member after the insertion of the implant, as is known from the prior art.

The implant can advantageously be connected to the prosthesis by means of an extension, which includes the interconnecting area and is a component of the implant.

An implant having an extension is a single-piece connection unit for prostheses. The mechanical stability of the connection and thus the ability of the dental prosthesis to withstand stress are improved as compared with a two-piece connection using an interconnecting member, for example.

An interconnecting recess corresponding to the interconnecting area of the extension can be computed automatically in the direction of the interconnecting axis on the lower side of the prosthesis.

Planning of the interconnecting recess takes place automatically and the time required for planning the prosthesis is thus reduced.

Advantageously, the position and orientation of the implant can be selected or determined automatically such that an implant having an extension can be taken from a plurality of implants having extensions, as stored in a memory and having a predefined interconnecting area between the extension and the prosthesis, on the one hand, and a predefined angle between the interconnecting axis and the longitudinal axis of the implant, on the other.

Data sets of implants having extensions are stored in the memory of a computer, for example. They have different interconnecting areas and different angles between the interconnecting axis and the longitudinal axis of the implant. The position and orientation of the implant and its extension are planned such that one of said stored implants having an extension can be used. Thus, pre-fabricated implants having extensions can be used and the time required for providing a dental prosthesis is reduced.

The prosthesis can be advantageously provided as a replacement for a plurality of teeth, in which case implants having an extension are inserted into the jaw and are connected to the prosthesis via the extensions, and the extensions of the individual implants are independently oriented along the respective interconnecting axes and are in fixed positional relationship to each other, and are connected to each other preferably via bridging members.

Thus, a stable basic construction of implants having extensions and bridging members is provided for a prosthesis as a replacement for a plurality of teeth. Each individual implant can be planned such that pre-fabricated implants having extensions can be used. This connection type is predominantly used for non-removable prostheses.

Advantageously, the prosthesis can be connected directly to the implant with the aid of a base member, which is a component of the prosthesis, and the interface between the base member and the implant corresponds to the interconnecting area.

The base member forms a suitable counterpart to mate with the contact surface of the implant and is planned and produced as a component of the prosthesis.

The position of the base member can be advantageously automatically computed with its orientation in the direction of the interconnecting axis.

The base member is directly connected to the contact surface of the implant. The resulting interface between the base member and the implant represents the interconnecting area.

The automatic planning of the base member reduces the time required for providing the dental prosthesis.

The prosthesis can be advantageously provided as a replacement for a plurality of teeth, in which case a plurality of base members connect the prosthesis to the implants along respective, independent interconnecting axes. These base members are in fixed positional relationship to each other and are connected to each other preferably by means of bridging members.

This provides a basic construction, which is integrated in the prosthesis, is consistent with the variably oriented implants, and ensures the required mechanical stability. This connection type is predominantly used for removable prostheses.

Advantageously, the prosthesis can be formed such that it can be separated from the interconnecting area and is thus removable.

The connection via a base part, a single-piece implant having an extension or a separate interconnecting member can be designed such that it can be separated. A prosthesis serving as a replacement for individual teeth or as a replacement for a plurality of teeth is thus removable.

The present invention further relates to a device for producing dental prosthetic items comprising an implant for inserting into the jaw and a prosthesis for attachment to an implant by means of an interconnecting area. A first scanned data set collected from a 3D radiograph is provided using an X-ray apparatus at the prosthesis-insertion site and is reproduced on a display unit as a 3D X-ray model.

A second scanned data set collected from a three-dimensional optical scan of the visible surface of the jaw and of at least parts of the neighboring teeth at the prosthesis-insertion site is provided using optical scanning means.

The scanned data set of the 3D radiograph is correlated with the scanned data set of the three-dimensional optical scan as to their geometries.

A data set of the surface of the prosthesis is prepared as a 3D prosthesis model by using data processing means.

The 3D prosthesis model is displayed in correct positional relationship in the correlated 3D X-ray model on the display unit. A data set of the implant in the correlated 3D X-ray model is likewise displayed on the display unit as a 3D implant model and can be positioned at least approximately by input means, but preferably automatically using the data processing unit, in the correlated 3D X-ray model, taking into consideration the 3D prosthesis model and the 3D X-ray model, and optionally selected with as to type of implant and adapted as to size.

The device of the invention thus comprises means that are able to implement the method of the invention.

A data set of the interconnecting area can be displayed advantageously as a 3D interconnecting model in correct positional relationship in the correlated 3D X-ray model and the shape of the 3D prosthesis model is automatically adjusted to the 3D interconnecting model of the interconnecting area by using data processing means.

The data processing means makes it possible to automatically adjust the displayed 3D prosthesis model to the displayed 3D interconnecting model. The digital surface data of the 3D prosthesis model are modified in the region of contact with the interconnecting area and adjusted to match the surface data of the 3D interconnecting model.

The present invention further relates to a drilling template for the creation of an implant bore, which drilling template is formed such that it is suitable for inserting the planned implant in accordance with the method of the invention.

The use of the drilling template makes it readily possible to create the implant bore in a precise manner and to insert the implant in accordance with its planned position and orientation.

### BRIEF DESCRIPTION OF THE DRAWINGS

The method and device of the invention are explained below with reference to the drawings, in which:

FIG. 1 shows a device for displaying various stored, addressable 3D models for implementing the method of the invention;

FIG. 2 shows a 3D restoration model of the jaw and of at least parts of the neighboring teeth in the region of the prosthesis to be inserted;

FIG. 3 is a view of a 3D radiograph model of both the jaws in the manner of a panoramic tomographic image;

FIG. 4 is a combined display of the 3D radiograph model and the 3D restoration model with cross-fading means;

FIG. 5 shows a 3D prosthesis model for a prosthesis in the 3D restoration model;

FIG. 6 shows the 3D prosthesis model shown in FIG. 5 in a section of the correlated 3D radiograph model shown in FIG. 3;

FIG. 7 is a view of the 3D radiograph model of both the jaws, shown in FIG. 3, with an envelope of all 3D implant models and the 3D prosthesis model as a solid body;

FIG. 8 shows two tomographic images of the 3D radiograph model, shown in FIG. 6, for the selection and positioning of the envelopes of all 3D implant models on the basis of anatomical structures;

FIG. 9 shows two tomographic images of the 3D radiograph model shown in FIG. 6 for positioning a selected 3D implant model and an interconnecting member, which is displayed as a 3D interconnecting model, within the 3D prosthesis model at an angle α of 180°;

FIG. 10 shows a drilling template for producing the implant bore and for inserting the implant;

FIG. 11 shows two tomographic images, as shown in FIG. 8, of the 3D radiograph model for positioning a selected 3D implant model and an interconnecting member, which is displayed as a 3D interconnecting model, within the 3D prosthesis model at an angle α of 160°;

FIG. 12 shows two tomographic images, as shown in FIG. 8, of the 3D radiograph model for positioning a selected 3D implant model and an interconnecting member, which is displayed as a 3D interconnecting model, at an angle α of 180° and an angle α of 22°;

FIG. 13 shows two tomographic images, as shown in FIG. 8, of the 3D radiograph model for positioning a selected 3D implant model and an interconnecting member, which is displayed as a 3D interconnecting model, for a single-piece implant having an extension at an angle α of 180°;

FIG. 14 shows two tomographic images, as shown in FIG. 8, of the 3D radiograph model for positioning a selected 3D implant model and a base member displayed as a 3D base member model;

FIG. 15 is a view of a section of the 3D radiograph model shown in FIG. 7 comprising a prosthesis, which is indirectly attached to four implants via interconnecting members;

FIG. 16 is a view of a section of the 3D radiograph model shown in FIG. 7 comprising a prosthesis that is attached to the jaw via four single-piece implants having extensions;

FIG. 17 is a view of a section of the 3D radiograph model shown in FIG. 7 comprising a prosthesis, which is attached to the jaw by way of base members with four implants.

### EXEMPLARY EMBODIMENT

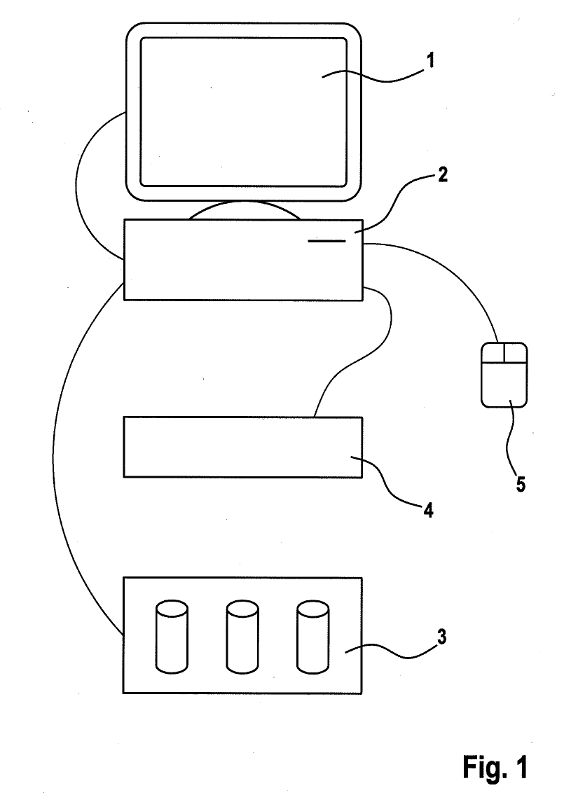

FIG. 1 shows a display unit 1, a data processing unit 2, a memory 3, and input means 4 and 5 for displaying various stored, addressable 3D models for implementing the method of the invention. The input means 4 and 5 are connected to the data processing unit 2 and serve the purpose of manually selecting and positioning the various 3D models. The data processing unit 2 makes it possible to automatically select, position, and adjust the 3D models. The 3D models are displayed on the display unit 1 for visual monitoring. The memory contains a plurality of data sets for 3D models, which can be displayed on the display unit and can be selected either manually by way of the input means 4 and 5 or automatically with the aid of the data processing unit 2.

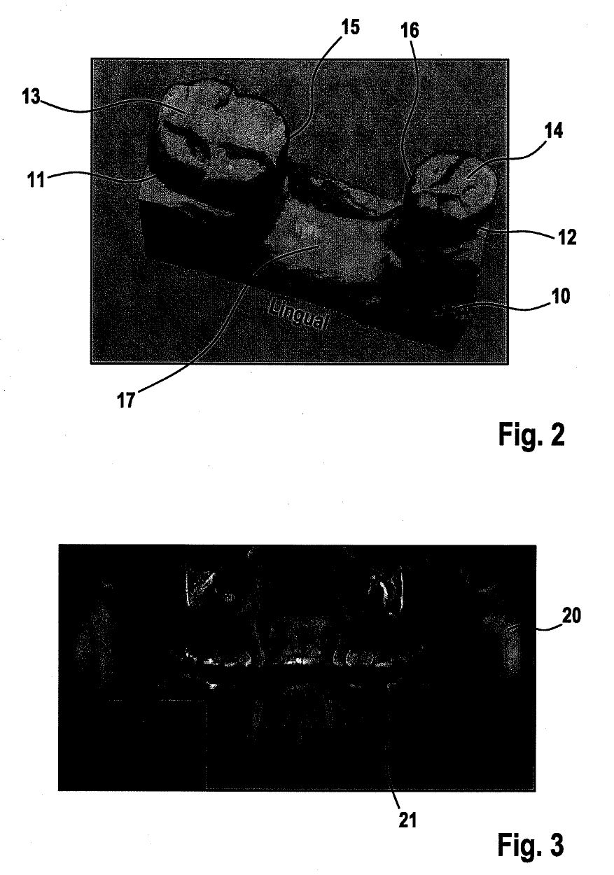

FIG. 2 shows a 3D restoration model 10 from a scanned data set obtained from a three-dimensional optical scan of the visible surface of the jaw and of at least parts of the neighboring teeth 11 and 12 at the site of insertion of the prosthesis. Occlusal surfaces 13 and 14, lateral surfaces 15 and 16 of the neighboring teeth, and a gingival surface 17 in the dental gap are of particular significance in planning an accurately fitting dental prosthesis.

FIG. 3 shows a 3D radiograph model 20 of both jaws as produced from a scanned data set obtained from a 3D radiograph. This 3D radiograph is a panoramic tomographic image. A dental gap 21 in the lower jaw at the third position from the right is to be provided with a dental prosthesis.

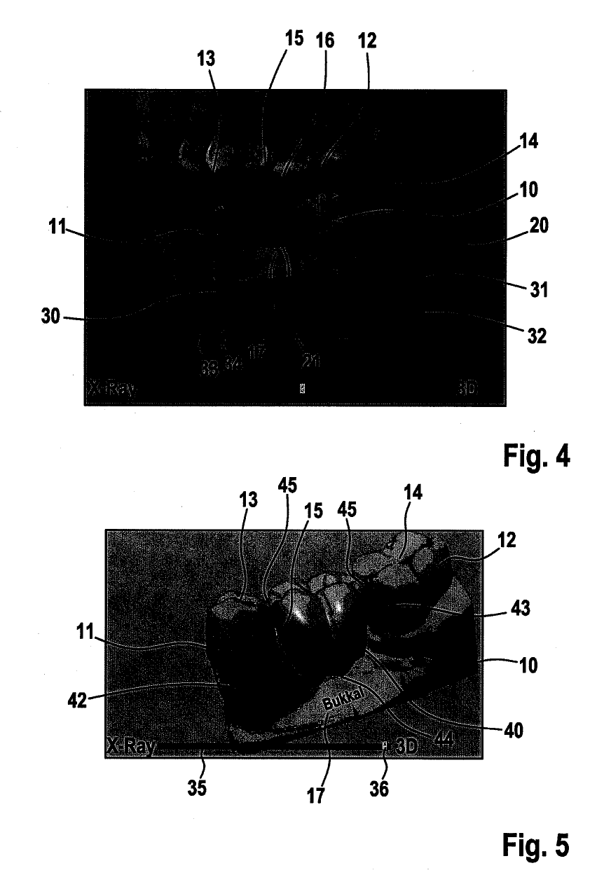

FIG. 4 is a combined display of the 3D radiograph model 20 produced from the scanned data set of the 3D radiograph and the 3D restoration model 10 produced from the scanned data set obtained by three-dimensional optical scanning. The scanned data set of the 3D radiograph image is correlated with the scanned data set obtained from three-dimensional optical scanning as to their geometries. On the one hand, visible structures such as the occlusal surfaces 13 and 14, lateral surfaces 15 and 16 of the neighboring teeth 11 and 12, and the gingival surface 17 in the dental gap 21 can be seen on the 3D restoration model 10, and, on the other hand, the otherwise hidden anatomical structures such as the roots 30 and 31 of the neighboring teeth 11 and 12, the jaw bone 32, and nerves 33 can be seen on the 3D radiograph model 20 in real geometrical relationship to each other. All the structures required for planning the prosthesis and the implant are thus shown. A slider 35 for controlling the cross-fade ratio of the combined display is shown below the latter. Only the 3D restoration model 10 is displayed when the slider is in its right-hand end position and only the 3D radiograph model 20 is displayed when the slider is in its left-hand end position 37. In the situation shown here, the slider 35 is in an intermediate position and the two models 10 and 20 are displayed in superimposition.

FIG. 5 shows a 3D prosthesis model 40 produced from a data set for a prosthesis fitting accurately between the neighboring teeth in the 3D restoration model 10. The 3D prosthesis model 40 is designed such that its occlusal surface 41 is located at the level of the occlusal surfaces 13 and 14 of the neighboring teeth 11 and 12 and that its lateral surfaces 42 and 43 fit accurately in relation to the lateral surfaces 15 and 16 of the neighboring teeth and that its boundary surface 44 is flush with the gingival surface 17 and that its occlusal surface 41 matches that of the opposing teeth. The slider 35 is at the right-hand end position 36 so that only the 3D restoration model 10 is displayed. The 3D prosthesis model 40 comes into contact with the neighboring teeth 11 and 12 at the interfaces 45. In the case of stress, contact forces are transferred to said interfaces 45.

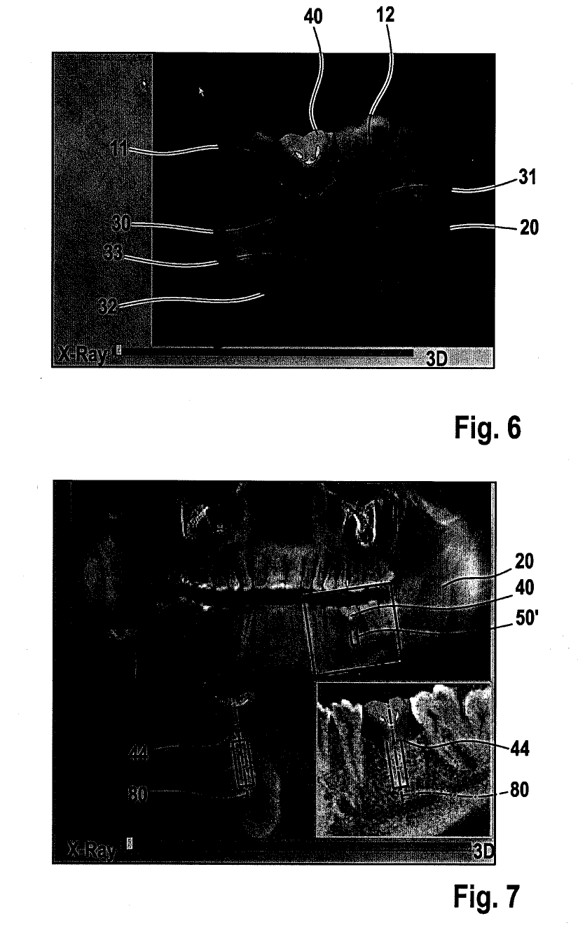

FIG. 6 shows the 3D prosthesis model 40 shown in FIG. 5 in a section of the correlated 3D radiograph model 20 shown in FIG. 3. The 3D prosthesis model 40 shown in FIG. 5 remains unchanged, and the slider 35 has been brought into the left-hand end position 37 so that the 3D radiograph model 20 is displayed exclusively while the 3D restoration model 10 is not visible. The planned 3D prosthesis model 40 is thus shown in its actual position and orientation in relation to the anatomical structures such as the tooth roots 30 and 31 of the neighboring teeth 11 and 12, the jaw bone 32, and nerves 33 displayed in the 3D radiograph model 20.

FIG. 7 shows the entire 3D radiograph model 20 of both jaws, shown in FIG. 3, with an envelope 50′ of all 3D implant models and the 3D prosthesis model 40 as a solid body. The envelope 50′ has the shape of a cylinder, which represents a quadrangle in cross-section. The envelope 50′ is dimensioned such that all types of implants for the respective tooth region fit into the envelope. Thus, implants having the same dimensions are normally used for each tooth region since the position and dimensions of the anatomical structures deviate only marginally from patient to patient. For example, shorter and broader implants are used in the case of molars and longer and narrower implants are used in the case of incisors. The envelope 50′ is oriented longitudinally of the prosthesis axis 80 as nearly as possible. The end surface of the envelope 50′ is positioned at the interface of the prosthesis axis 80 with the boundary surface 44 of the 3D prosthesis model 40 or slightly above the same. Rough positioning of the envelope 50′ takes place automatically and can be readjusted subsequently with the aid of the input means.

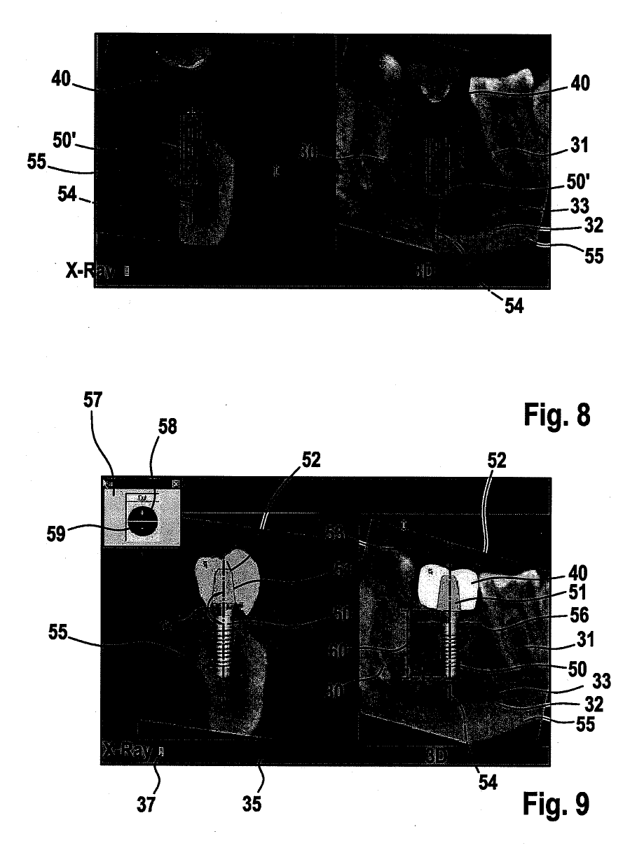

The right half of FIG. 8 shows a first cross-sectional representation of the 3D radiograph model 20, shown in FIG. 6, taken longitudinally of the jaw for fine positioning of the envelope 50′, taking into consideration the anatomical structures 30, 31, 32, and 33 in the 3D radiograph model 20.

The cross-sectional representation is a tomographic image 55 pertaining to the 3D radiograph model 20, which is taken longitudinally of the jaw, and which represents a computed volume data set, as generated by means of a panoramic tomographic image. In the panoramic tomographic image, a scanned data set of the recorded object is computed by means of image reconstruction using radiographs produced from different directions. This scanned data set contains absorption coefficients of individual volume elements of the object recorded. In this case, the scanned data set is represented as the 3D radiograph model 20. The dimension of a volume element sets the minimum layer thickness of a tomographic image 55 at 0.15 mm. The layer thickness of the tomographic image 55 represented can also be selected such that it is greater than the minimum layer thickness of 0.15 mm. The represented tomographic image 55 shown and produced from the 3D radiograph model 20 is selected in such a way that a longitudinal axis 54 of the positioned 3D implant model 50 is located in the plane of the tomographic image 55.

The left half of FIG. 8 shows a second tomographic image 55 produced from the 3D radiograph model 20, shown in FIG. 6, taken transversely to the jaw for fine positioning of the envelope 50′, taking into consideration the anatomical structures 30, 31, 32, and 33 in the 3D radiograph model 20.

Fine positioning of the envelope 50′ can be effected automatically or with the aid of the input means 4, 5. During automatic positioning, the anatomical structures 30, 31, 32, and 33 must be recognized by the data processing unit 1 as volume areas with defined boundaries in order to place the envelope 50′ at an appropriate distance from these anatomical structures during fine positioning.

The right half of FIG. 9 is a first sectional representation of the 3D radiograph model 20, shown in FIG. 6, taken longitudinally of the jaw for positioning the selected 3D implant model 50, which is positioned within the envelope 50′ and oriented longitudinally of the longitudinal axis 54. The selected 3D implant model 50 is thus at a greater distance from the anatomical structures 30, 31, 32, and 33 than the envelope 50′. In the case shown, a 3D implant model 50 comprising an interconnecting member displayed as a 3D interconnecting model is represented within the 3D prosthesis model at an angle α of 180°; and a 3D interconnecting model 51 of an interconnecting member is shown for selection and positioning. Said interconnecting model 51 comprises an interconnecting area 52 for the 3D prosthesis model 40 and its interconnecting axis 53 coincides with a longitudinal axis 54 of the 3D implant 50.

The implant is indirectly connected to the prosthesis via an interconnecting member shown as the 3D interconnecting model 51.

The sectional representation is a tomographic image 55 produced from the 3D radiograph model 20, which is taken longitudinally of the jaw, represents a computed volume data set, and is generated by means of a panoramic tomographic image. In the panoramic tomographic image, a scanned data set of the recorded object is computed using radiographs produced by means of image reconstruction from different directions. This scanned data set contains absorption coefficients of individual volume elements of the object recorded. In this case, the scanned data set is shown as the 3D radiograph model 20. The dimension of a volume element sets the minimum layer thickness of a tomographic image 55 at 0.15 mm. The layer thickness can be selected such that it is greater than the minimum layer thickness of 0.15 mm. The tomographic image 55 shown is selected in such a way from the 3D radiograph model 20 that a longitudinal axis 54 of the positioned 3D implant model 50 is located in the plane of the tomographic image 55.

If the diameter 56 of the positioned 3D implant model 50 is larger than the layer thickness of the tomographic image 55, adjacent tomographic images are observed. A control element 57 comprising two pushbuttons 58 and 59 is provided for this purpose. Upon activation of the upper pushbutton 58, the adjacent layer located behind the tomographic image 55 is displayed, and upon activation of the lower pushbutton 59, the adjacent layer located in front of the tomographic image 55 is displayed. This makes it possible to navigate through the layers of the 3D radiograph model 20. When activating the control element, the sectional representations of the 3D prosthesis model 40 and the 3D interconnecting model 51 present therein are displaced by the layer thickness so that the sectional representations of the 3D prosthesis model 40 and the 3D interconnecting model 51 are located in the same plane as the displayed layer of the 3D radiograph model 20.

The type, dimensions, position, and orientation of the 3D implant model 50 are selected in a first step. On the other hand, the type and dimensions such as the diameter 56 and the length 60, for example, can be selected such that the stress caused by the contact forces between the contact surfaces of the prosthesis and the neighboring teeth does not result in a fracture of the implant or interconnecting member. The dimensions 56 and 60, the position, and orientation of the longitudinal axis 54 must be selected such that the anatomical structures 30, 31, 32, 33, und 34 in the 3D radiograph model 20 are taken into consideration.

The control element 57 and the slider 35, on the one hand, can be activated and the 3D implant model 50 and the 3D interconnecting model 51, on the other hand, can be selected and positioned manually with the aid of the input means 4 and 5 shown in FIG. 1.

Alternatively, the 3D implant model 50 can be selected and positioned automatically taking into account the aforementioned conditions by means of the data processing unit 2 shown in FIG. 1.

In the second step, the interconnecting area 52 of the 3D interconnecting model 51 for joining to the 3D prosthesis model 40, on the one hand, and the angle α between the interconnecting axis 53 of the 3D interconnecting model 51 and the longitudinal axis 54 of the 3D implant model 50, on the other, are selected. The distance 61 between the 3D interconnecting model 51 and the edge of the 3D prosthesis model 40 must not exceed a predefined value in order to ensure the required stability of the prosthesis.

The 3D implant model 50 is selected from a plurality of 3D implant models and the 3D interconnecting model 51 is selected from a plurality of 3D interconnecting models, which are stored in the memory 3 shown in FIG. 1, and the associated implants and interconnecting members are present in pre-fabricated form. The angle α is thus selected in such a way that a pre-fabricated interconnecting member having this angle α can be used. In this case, an angle α of 180° is selected, that is to say, the parts are in alignment.

The left half of FIG. 8 shows a second tomographic image 55 produced from the 3D radiograph model 20, shown in FIG. 6, taken transversely to the jaw for selecting and positioning the 3D implant model 50 and the 3D interconnecting model 51, as shown in the right-hand part of FIG. 8.

The spatial position and orientation are determined after positioning the 3D prosthesis model 50 and the 3D interconnecting model 51 longitudinally of and transversely to the jaw.

FIG. 9 shows a drilling template 70 comprising contact surfaces 71 and 72 on the occlusal surfaces 13 and 14 of the neighboring teeth 11 and 12, shown in FIG. 4, for inserting the implant based on the 3D implant model 50 shown in FIG. 8. The contact surfaces 71 and 72 are formed as negative impressions of the occlusal surfaces 13 and 14 of the neighboring teeth 11 and 12. The drilling template 70 comprises a guide hole 73, to assist the creation of an implant bore 74 in the jawbone 32 and for inserting the implant planned. The center axis 75 of the guide 74 coincides with the longitudinal axis 54 of the planned implant. The drilling template 70 can be planned automatically by means of the data processing means 2 implementing the data on the occlusal surfaces 13 and 14 of the neighboring teeth in the 3D restoration model 10, on the one hand, and the data on the position and orientation of the longitudinal axis 54, the diameter 56, and the length 60 of the 3D implant model 50, on the other.

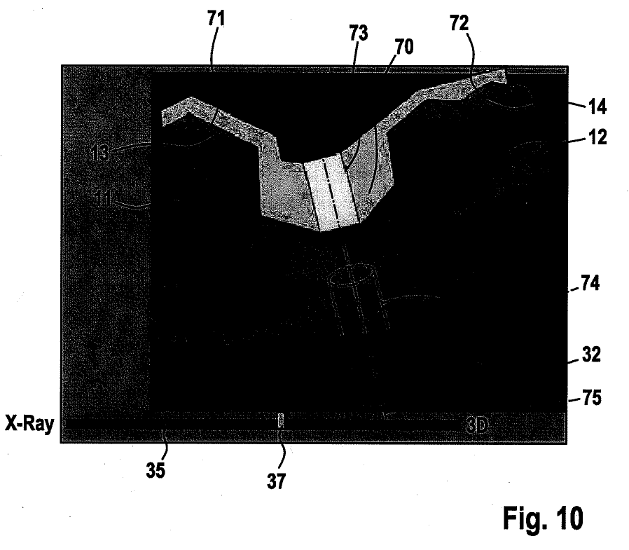

FIG. 10a shows a first tomographic image 55 produced from the 3D radiograph model 20 taken longitudinally of the jaw and FIG. 10b shows a second tomographic image 55 produced from the 3D radiograph model 20 taken transversely to the jaw, as shown in FIG. 8, for positioning the 3D implant model 50 and the 3D interconnecting model 51 of the interconnecting member. The 3D interconnecting model 51 comprises an interconnecting area 52, which is oriented longitudinally of the interconnecting axis 53. The angle α between the interconnecting axis 53 of the interconnecting member and the longitudinal axis 54 of the implant is 160°, the two axes 53 and 54 being located in a plane extending longitudinally of the jaw. The orientation of the 3D prosthesis model 40 is characterized by a prosthesis axis 80, which is normal to the occlusal surface 41 of the 3D prosthesis model 40. In the case illustrated, the prosthesis axis 80 coincides with the interconnecting axis 53. When positioning the 3D implant model 50, anatomical structures 30, 31, 32, 33, and 34 are taken into consideration and the 3D interconnecting model 51 is selected, preferably automatically, to matching an interconnecting member having an angle α of 160°.

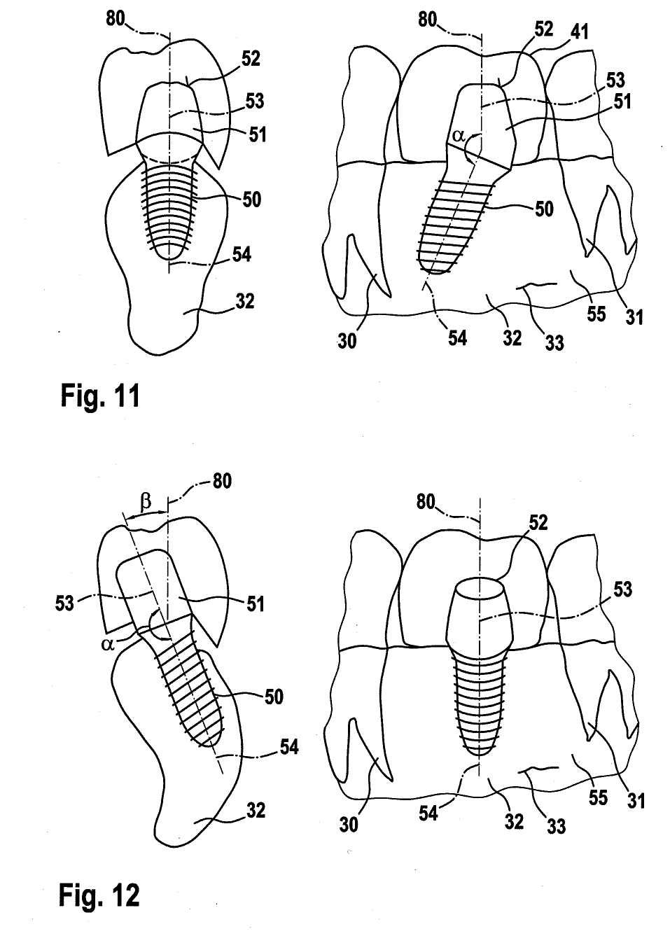

FIG. 11a shows a first tomographic image 55 produced from the 3D radiograph model 20 taken longitudinally of the jaw and FIG. 11b shows a second tomographic image 55 produced from the 3D radiograph model 20 taken transversely to the jaw for positioning the selected 3D implant model 50 and the 3D interconnecting model 51 with the interconnecting area 52 of the interconnecting member. The interconnecting axis 53 of the interconnecting member coincides with the longitudinal axis 54 of the implant. The prosthesis axis 80 is located at an angle β of 20° in relation to the interconnecting axis 53 and the two axes are located in a plane extending transversely to the jaw.

FIG. 12a shows a first tomographic image 55 of the 3D radiograph model 20 taken longitudinally of the jaw and FIG. 12b, shows a second tomographic image 55 of the 3D radiograph model taken transversely to the jaw for positioning a selected single-piece implant having an extension. The lower implant part, which is implanted in the jaw bone, is shown as the 3D implant model 50, and the extension, which is connected to the prosthesis, is shown as the 3D interconnecting model 51 with an interconnecting area 52. The prosthesis axis 80, the interconnecting axis 53 of the extension, and the longitudinal axis 54 of the lower implant part coincide.

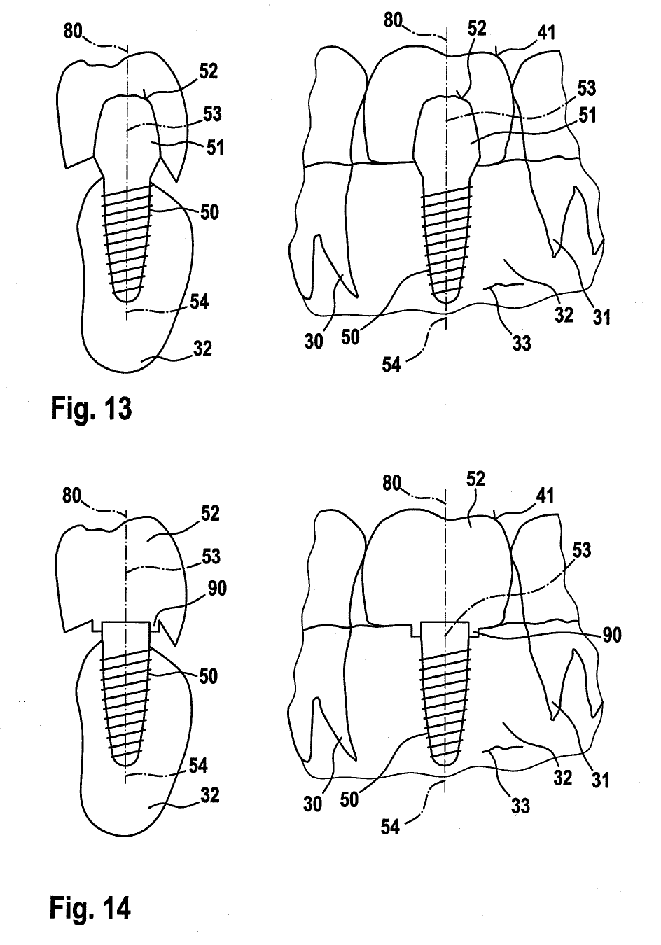

FIG. 13a shows a first tomographic image 55 of the 3D radiograph model 20 taken longitudinally of the jaw and FIG. 13b shows a second tomographic image 55 of the 3D radiograph model 20 taken transversely to the jaw with a base member, which is shown as a 3D base member model 90 and is connected to the implant shown as a 3D implant model 50. The prosthesis axis 80, the interconnecting axis 53 of the 3D base member model 90 and the longitudinal axis 54 of the 3D implant model 50 coincide. The 3D base member model 90 comprises the interconnecting area 52 for joining to the 3D implant model 50. The prosthesis is removable since the base member is designed such that it can be separated from the implant.

FIG. 14 is a view of a section of the 3D radiograph model 20, shown in FIG. 7, of the entire lower jaw comprising a 3D prosthesis model 40 for a prosthesis as a replacement for all the teeth of the lower jaw. The prosthesis is attached to the jaw by way of four interconnecting members with the respective implants, which interconnecting members are permanently connected to each other with the aid of bridge members. The 3D interconnecting models 51.1 to 51.4 with interconnecting areas 52.1 to 52.4 of the interconnecting members are independently oriented longitudinally of the respective interconnecting axes 53.1 to 53.4, and the 3D implant models 50.1 to 50.4 are oriented longitudinally of the respective longitudinal axes 54.1 to 54.4. The 3D implant models and the 3D interconnecting models were selected, preferably automatically, from a plurality of 3D implant models having predefined dimensions and a predefined angle α, taking into consideration the anatomical structures and the 3D prosthesis model 40.

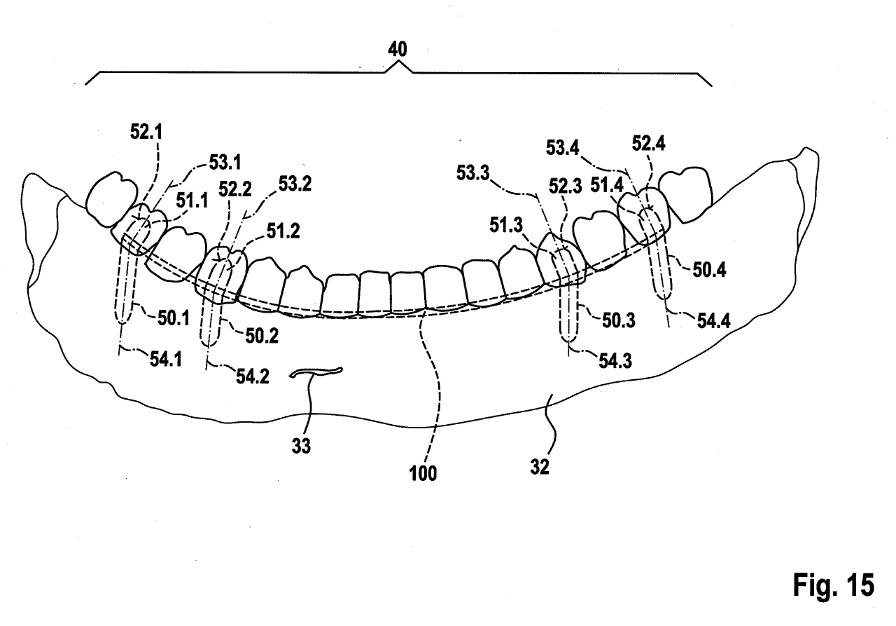

FIG. 15 is a view of a section of the 3D radiograph model 20, shown in FIG. 7, of the entire lower jaw comprising a 3D prosthesis model 40 for a prosthesis as a replacement for all the teeth of the lower jaw, as shown in FIG. 4. The prosthesis is attached to the jaw with the aid of four single-piece implants having extensions, which are permanently connected to each other with the aid of bridge members. The 3D interconnecting models 51.1 to 51.4 with interconnecting areas 52.1 to 52.4 of the extensions are independently oriented longitudinally of the respective interconnecting axes 53.1 to 53.4, and the 3D implant models 50.1 to 50.4 of the lower implant parts are oriented longitudinally of the respective longitudinal axes 54.1 to 54.4. The 3D implant models 50.1 to 50.4 and the 3D interconnecting models 51.1 to 51.4 of single-piece implants with extensions were selected, preferably automatically, from a plurality of 3D implant models and 3D interconnecting models having predefined dimensions and a predefined angle α, taking into consideration the anatomical structures and the 3D prosthesis model 40.

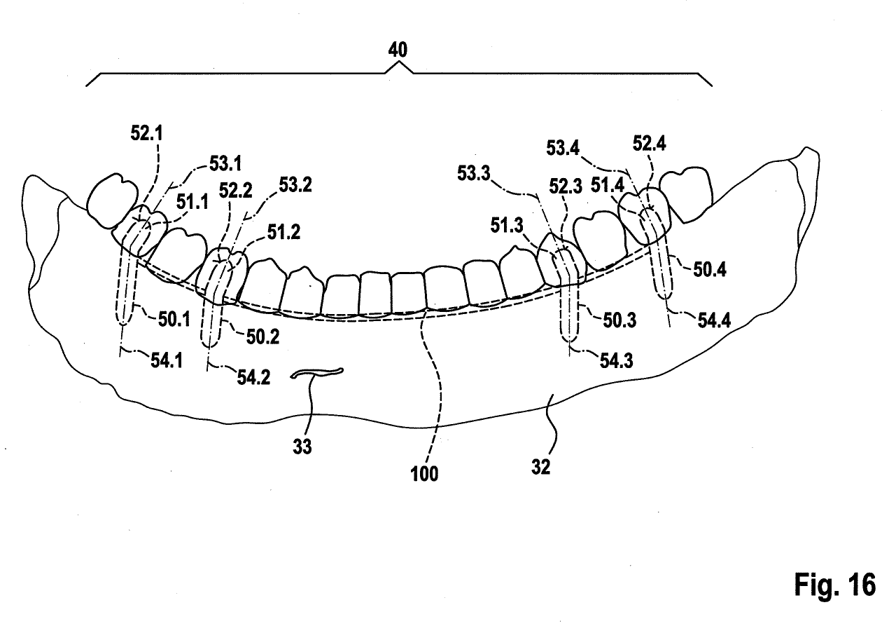

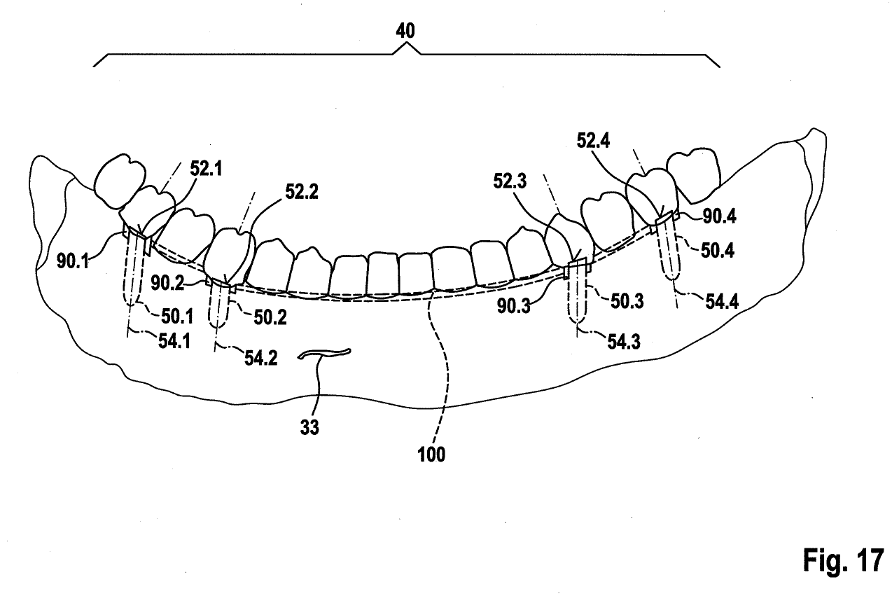

FIG. 16 is a view of the 3D radiograph model 20, as shown in FIG. 14, of the lower jaw comprising a 3D prosthesis model 40 for a prosthesis as a replacement for all the teeth of the lower jaw. The prosthesis is attached to the jaw by way of base members shown as 3D base member models 90.1 to 90.4 with four implants shown as 3D implant models 50.1 to 50.4, the base members being components of the prosthesis 40. The 3D base member models 90.1 to 90.4 comprise interconnecting areas 52.1 to 52.4. The base members are connected to each other with the help of bridge members and are in fixed positional relationships to each other. The base members are designed to be separated from the implants such that the prosthesis can be removed. The 3D implant models 50.1 to 50.4 were selected from a plurality of 3D implant models having predefined dimensions and were positioned, preferably automatically, taking into consideration the anatomical structures. The 3D base member models 90.1 to 90.4 are positioned, preferably automatically, such that they match the upper surface 100 of the implant and are located longitudinally of the longitudinal axis 54 of the implant.

### LIST OF REFERENCE NUMERALS OR CHARACTERS

1 display unit
2 data processing unit
3 memory
4 input means
5 input means
10 3D restoration model
11 neighboring tooth
12 neighboring tooth
13 occlusal surface
14 occlusal surface
15 lateral surface
16 lateral surface
17 gingival surface
20 3D X-ray model
21 dental gap
30 dental root
31 dental root
32 jawbone
33 nerves
35 slider
36 right-hand end position
37 left-hand end position
40 3D prosthesis model
41 occlusal surface
42 lateral surface
43 lateral surface
44 interface
45 contact surfaces against neighboring teeth
50 3D implant model
51 3D interconnecting model
52 interconnecting area
53 interconnecting axis
54 longitudinal axis of the implant
55 tomographic image
56 diameter of the 3D implant model
57 control means
58 upper push-button
59 lower push-button
60 length of the 3D implant model
61 distance between the 3D connecting model and the edge of the 3D prosthesis model
70 drilling template
71 contact surface
72 contact surface
73 guide hole
74 implant drill hole
80 prosthesis axis
90 3D base member model
100 bridging member
α angle between the connecting axis and the longitudinal axis of the implant
β angle between the prosthesis axis and the connecting axis

1. A method for the production of a dental prosthesis, the dental prosthesis consisting of a prosthesis for attachment to an implant to be implanted in a jaw, which attachment is effected via an interconnecting area, the method comprising:
providing a correlated 3D X-ray model, in which a scanned data set collected from a 3D radiograph is correlated with a scanned data set collected from a three-dimensional optical scan with regard to their geometries, the first scanned data set collected from said 3D radiograph and the second scanned data set collected from said three-dimensional optical scan of the visible surface include the prosthesis-insertion site including the jaw and at least parts of the neighboring teeth;
providing a data set collected from at least the surface of the prosthesis as a 3D prosthesis model;
displaying said 3D prosthesis model in the correlated 3D X-ray model on the display unit in correct positional relationship and on said display unit together with said 3D X-ray model;
displaying a data set of the implant in said correlated 3D X-ray model on the display unit as a 3D implant model and which can be at least approximately positioned in said correlated 3D X-ray model via input means or automatically while taking into consideration said 3D prosthesis model and said 3D X-ray model.

2. The method as defined in claim 1, further comprising automatically determining said 3D implant model as to its position and/or its orientation and/or its type and/or its length and/or its diameter while taking into consideration said 3D prosthesis model, namely while taking into consideration its position and/or its orientation and/or its size and/or its boundary surface against a gingival surface revealed in said three-dimensional optical scan and/or its contact surfaces against said neighboring teeth.

3. The method as defined in claim 1, further comprising automatically selecting the position and orientation of said 3D implant model while taking into consideration the anatomic structures in said jaw as revealed in said 3D X-ray model.

4. The method as defined in claim 1, further comprising automatically selecting the diameter and length of said 3D implant model making allowance for stresses to be expected from contact pressure acting on said contact surfaces of said prosthesis.

5. The method as defined in claim 1, wherein said 3D implant model has a longitudinal axis, said interconnecting area has a connecting axis that substantially corresponds to the axis of insertion of said prosthesis and said 3D prosthesis model has a prosthesis axis, and said 3D implant model can be modified as to position and orientation such that the angle β between said prosthesis axis and said connecting axis is not more than 30°, and said connecting axis is oriented such that the insertion of said prosthesis along said axis of insertion is not hindered by said neighboring teeth to more than an insignificant extent.

6. The method as defined in claim 5, wherein said 3D implant model has a longitudinal axis and said interconnecting area has a connecting axis that represents the insertion direction of said prosthesis, and said angle α between said longitudinal axis and said connecting axis is automatically selected from a plurality of specified angles ranging from 140° to 180°.

7. The method as defined in claim 1, further comprising displaying a data set of said interconnecting area as a 3D connecting model in correct positional relationship in said correlated 3D X-ray model and automatically adjusting said 3D prosthesis model as to shape to fit said interconnecting area of said 3D connecting model.

8. The method as defined in claim 1, further comprising displaying said scanned data set collected from a 3D radiograph as said 3D X-ray model and displaying said scanned data set collected from said three-dimensional optical scan as a 3D restoration model both on said display unit correlated by their geometries and input means are provided for selecting the cross-fade ratio between said two models.

9. The method as defined in claim 1, further comprising constructing a drilling template taking into consideration the selected position and orientation of said 3D implant model and with reference to occlusal surfaces of said neighboring teeth shown in said scanned data set collected from said three-dimensional optical scan.

10. The method as defined in claim 9, wherein said drilling template is formed such that it is suitable for the insertion of said implant, displayed as said 3D implant model.

11. The method as defined in claim 1, wherein said prosthesis is indirectly connected to said implant via a separate connecting member, which interconnecting member includes the interconnecting area to join to the prosthesis and is connected to said implant.

12. The method as defined in claim 11, further comprising automatically computing an interconnecting recess corresponding to said interconnecting area on said connecting member, in said prosthesis in the direction of said connecting axis on the underside of said prosthesis and displaying it in said 3D prosthesis model.

13. The method as defined in claim 11, further comprising selecting or automatically determining the position and orientation of said implant such that a connecting member can be used that is taken from a plurality of connecting members stored in a memory and having a specified interconnecting area between said connecting member and said prosthesis, on the one hand, and a specified angle α between said connecting axis and said longitudinal axis of said implant, on the other.

14. The method as defined in claim 1, wherein said implant is connected to said prosthesis via an extension containing said interconnecting area, said extension being a component of the implant.

15. The method as defined in claim 14, further comprising automatically computing an interconnecting recess corresponding to said interconnecting area on said extension in the direction of said connecting axis on the underside of said prosthesis.

16. The method as defined in claim 14, further comprising selecting or automatically determining the position and orientation of said implant such that an implant having an extension can be used taken from a plurality of implants having an extension that are stored in a memory and have a specified interconnecting area between extension and prosthesis, on the one hand, and a specified angle α between said connecting axis and said longitudinal axis of said implant, on the other.

17. The method as defined in claim 14, wherein said prosthesis serves as a replacement for a plurality of teeth, and a plurality of implants having an extension are implanted in the jaw and connected to the prosthesis via said extensions the extensions of the individual implants being independently oriented along the respective connecting axes in fixed positional relationship to each other and interconnected preferably via bridging members.

18. The method as defined in claim 1, wherein said prosthesis is directly connected to said implant via a base element, and said base element is a component of said prosthesis and the interface between said base element and said implant corresponds to said interconnecting area.

19. The method as defined in claim 17, wherein the position of said base element is automatically computed with an orientation in the direction of said connecting axis.

20. The method as defined in claim 18 wherein said prosthesis serves as a replacement for a plurality of teeth, and a plurality of base elements connect said prosthesis to implants along the respective independent connecting axes with a fixed positional relationship to each other and are interconnected via bridging members.

21. The method as defined in wherein said prosthesis can be separated from said interconnecting area and is thus removable.

22. A device for the production of a dental prosthesis, the dental prosthesis consisting of a prosthesis for attachment to an implant for implantation in a jaw, wherein attachment thereof is effected via an interconnecting area and a correlated 3D X-ray model is present, wherein a scanned data set collected from a 3D radiograph is correlated with a scanned data set collected from a three-dimensional optical scan as to the geometries thereof, and the first scanned data set collected from the 3D radiograph and the second scanned data set collected from the three-dimensional optical scan of the visible surface include the prosthesis-insertion site including the jaw and at least parts of the neighboring teeth wherein a data set collected from at least the surface of the prosthesis is provided as a 3D prosthesis model, said 3D prosthesis model is displayed in the correlated 3D X-ray model on the display unit in correct positional relationship and is displayed on said display unit together with said 3D X-ray model, a data set of the implant is displayed in said correlated 3D X-ray model on the display unit as a 3D implant model and can be at least approximately positioned in said correlated 3D X-ray model via input means or automatically while taking into consideration said 3D prosthesis model and said 3D X-ray model and can furthermore preferably either be selected as to type and/or be adapted as to size.

23. The device as defined in claim 22, wherein a data set collected from an interconnecting area for connecting said prosthesis to an implant is displayed in correct positional relationship as a 3D interconnecting model in said correlated 3D X-ray model and that said 3D prosthesis model is automatically adapted as to shape to said 3D interconnecting model of said interconnecting area using said data processing means.
